(19) United States
(12) Patent Application Publication
(10) Pub. No.: US 2024/0158252 A1
(43) Pub. Date: May 16, 2024

(54) MATERIALS, METHODS AND TECHNIQUES FOR CONVERTING RARE EARTH DOUBLE SULFATES INTO RARE EARTH CARBONATES

(71) Applicant: Lynas Rare Earths Limited, East Perth WA (AU)

(72) Inventors: Wan Nursyamimi Wan Hasbullah, Kuantan (MY); Luke Darbyshire, Kuantan (MY); Norazihan Zulkifli, Kuantan (MY); Aznor Yahya, Kuantan (MY)

(21) Appl. No.: 18/501,478

(22) Filed: Nov. 3, 2023

Related U.S. Application Data
(60) Provisional application No. 63/382,155, filed on Nov. 3, 2022.

(51) Int. Cl. C01F 17/247; B01J 19/00

(52) U.S. Cl. CPC C01F 17/247; B01J 19/0013; B01J 19/0066; B01J 2219/00051

(57) ABSTRACT

Mixed rare earth carbonate may be prepared by mixing a rare earth double sulfate salt solid with a conversion agent comprising a sodium carbonate (Na₂CO₃) solution, to form a slurry mixture, and generating a low sulfate rare earth carbonate wet cake from the slurry mixture.

### CROSS-REFERENCE TO RELATED APPLICATION(S)

This application claims priority to U.S. Provisional Patent Application No. 63/382,155 filed on Nov. 3, 2022, the entire contents of which are incorporated herein by reference.

### TECHNICAL FIELD

The present disclosure relates to rare earth carbonates. More specifically, materials and methods disclosed and contemplated herein relate to production of rare earth carbonates from rare earth double sulfate salts.

### INTRODUCTION

Rare earths may be obtained through the processing of mined rare earth minerals. These mined rare earth minerals are processed in a sequential manner until they are of a form that may be used as an input to rare earth separation processes. Monazite, a rare earth mineral, is processed by mining and acid cracking using concentrated sulfuric acid, followed by leaching in water. The output of this sequential process is often a rare earth double sulfate salt. Before the rare earth double sulfate salt may be introduced into a solvent extraction process to separate the rare earth elements, the rare earth double sulfate salt must be converted to a rare earth chloride solution, which can be further processed to isolate various rare earths of interest.

Generally, the method currently used for producing mixed rare earth chloride solution from mixed rare earth double sulfate salt involves converting the mixed rare earth double salt to mixed rare earth hydroxide with caustic soda and, downstream, dissolving with hydrochloric acid. This process will produce a mixed rare earth chloride solution with low sulfate content.

The instant disclosure is directed to methods of producing a mixed rare earth carbonate with low sulfate content in a continuous manner from a mixed rare earth double sulfate salt using sodium carbonate. Resulting mixed rare earth carbonates can be dissolved in hydrochloric acid to produce a mixed rare earth chloride solution, which in turn can be used as an input to a rare earth solvent extraction process.

### SUMMARY

A method for preparing a rare earth carbonate (La,Ce,Nd,Pr)₂(CO₃)₃) with low sulfate is disclosed. The method may include mixing a rare earth double sulfate salt (Na₂(La,Ce,Nd,Pr)(SO₄)₂H₂O) with a sodium carbonate (Na₂CO₃) solution, thereby continuously forming a rare earth carbonate cake with low sulfate content.

In some aspects, the techniques described herein relate to a method for preparing a rare earth carbonate, the method including: mixing a rare earth double sulfate salt with a conversion agent including a sodium carbonate (Na₂CO₃) solution, thereby forming a slurry mixture; generating a low sulfate rare earth carbonate wet cake from the slurry mixture, wherein generating the low sulfate rare earth carbonate wet cake from the slurry mixture includes: agitating the slurry mixture; filtering the slurry mixture to generate a filter cake; and washing the filter cake with water, the low sulfate rare earth carbonate wet cake including no more than 2 weight percent sulfate (SO₄²⁻).

In some aspects, the techniques described herein relate to a system for generating rare earth carbonates, the system including: a vessel in fluid communication with a rare earth double sulfate salt source and a sodium carbonate (Na₂CO₃) solution source, the vessel including vessel agitation apparatus; and a filter unit in fluid communication with the vessel.

In some aspects, the techniques described herein relate to a method for preparing a rare earth carbonate, the method including: mixing a rare earth double sulfate salt with a conversion agent including a sodium carbonate (Na₂CO₃) solution, thereby forming a slurry mixture, wherein a solids content of the slurry mixture is 30 wt % to about 40 wt %; and generating a low sulfate rare earth carbonate wet cake from the slurry mixture, the low sulfate rare earth carbonate wet cake including between 0.1 weight percent (wt %) and 2 wt % sulfate (SO₄²⁻); wherein generating the low sulfate rare earth carbonate wet cake from the slurry mixture includes: agitating the slurry mixture; filtering the slurry mixture to generate a filter cake; and washing the filter cake with water.

There is no specific requirement that a material, technique or method relating to rare earth carbonates include all of the details characterized herein to obtain some benefit according to the present disclosure. Thus, the specific examples characterized herein are meant to be exemplary applications of the techniques described, and alternatives are possible.

### BRIEF DESCRIPTION OF THE DRAWING

FIG. 1 is a flowchart of an exemplary method for generating low sulfate mixed rare earth carbonate.

FIG. 2 is a schematic depiction of an exemplary system for generating low sulfate mixed rare earth carbonate.

FIG. 3 shows XRD traces for experimental Examples 1 to 9 and Sample 10.

### DETAILED DESCRIPTION

Materials, methods and techniques disclosed and contemplated herein relate to generating mixed rare earth carbonates. Generally, exemplary mixed rare earth carbonates may be generated with sulfate removal operations. These operations may be performed as continuous processes. Exemplary mixed rare earth carbonates may comprise less than about 2 weight percent (wt. %) sulfate.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The modifiers “about” or “approximately” used in connection with a quantity are inclusive of the stated value and has the meaning dictated by the context (for example, it includes at least the degree of error associated with the measurement of the quantity). These modifiers should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

### II. Exemplary Materials

Exemplary methods and techniques use and generate various materials. Example materials include mixed rare earth double sulfate salts, conversion agents comprising sodium carbonate (Na₂CO₃) solutions, and rare earth carbonates.

### A. Exemplary Mixed Rare Earth Double Sulfate Salts

Exemplary mixed rare earth double sulfate salts comprise one or more rare earth components solidified as a double sulfate salt solid. Sulfate is typically defined as an anion with a formula SO₄ and charge of negative 2. Sometimes sulfate anion is referred by the formula SO₄²⁻.

A double sulfate salt is a sulfate salt that comprises more than one different cation. In some instances, exemplary cations may include alkali, alkaline, and rare earth cations. Example alkali and alkaline cations solidified as mixed rare earth double sulfate salts can include, without limitation, sodium, potassium, calcium, and/or magnesium. Example rare earths cations solidified as mixed rare earth double sulfate salts can include, without limitation, lanthanum (La), cerium (Ce), neodymium (Nd), and/or praseodymium (Pr). In some instances, exemplary mixed rare earth sulfate salts comprise one or more impurities. Example impurities include, but are not limited to, silica, iron, and aluminum.

Various systems and methods may utilize and/or generate mixed rare earth double sulfate solutions. Exemplary mixed rare earth double sulfate solutions are aqueous, where water is the solvent.

In some instances, mixed rare earth double sulfate solutions may have a rare earth oxide concentration of about 30 weight percent (wt %) to 40 wt %, alternatively referred to as total rare earth oxide (TREO) concentration. Exemplary rare earth oxides may include La₂O₃, Ce₂O₃, Nd₂O₃, and/or Pr₂O₃. In various implementations, mixed rare earth double sulfate solutions may have a rare earth oxide (REO) concentration of 30 wt % to 40 wt % REO; 30 wt % to 35 wt % REO; 35 wt % to 40 wt % REO; 30 wt % to 33 wt % REO; 33 wt % to 37 wt % REO; 34 wt % to 36 wt % REO; or 36 wt % to 40 wt % REO. In various implementations, mixed rare earth double sulfate solutions may have a rare earth concentration of no less than 30 wt % REO; no less than 32 wt % REO; no less than 35 wt % REO; no less than 38 wt % REO; or no less than 40 wt % REO. In various implementations, mixed rare earth double sulfate solutions may have a rare earth concentration of no greater than 40 wt % REO; no greater than 37 wt % REO; no greater than 35 wt % REO; no greater than 33 wt % REO; or no greater than 31 wt % REO.

### B. Exemplary Conversion Agents

Exemplary conversion agents typically comprise sodium carbonate (Na₂CO₃) solutions. In some instances, exemplary conversion agents consist essentially of sodium carbonate (Na₂CO₃) solution. In some instances, exemplary conversion agents consist of sodium carbonate (Na₂CO₃) solution. Exemplary sodium carbonate (Na₂CO₃) solutions are typically aqueous. An exemplary solvent for sodium carbonate (Na₂CO₃) solutions is water.

In some instances, a concentration of the sodium carbonate (Na₂CO₃) solution may be about 10 wt. % to about 30 wt. % Na₂CO₃. In various implementations, a concentration of the sodium carbonate (Na₂CO₃) solution may be at least 10 wt. %; at least 20 wt. %; or at least 30 wt. %. In various implementations, a concentration of the sodium carbonate (Na₂CO₃) solution may be no more than 30 wt. %; no more than 20 wt. %; or no more than 10 wt. %. In various implementations, a concentration of the sodium carbonate (Na₂CO₃) solution may be 10-30 wt. %; 10-20 wt. %; or 20-30 wt. %.

### C. Exemplary Rare Earth Carbonates

Exemplary systems, methods and techniques may generate low sulfate rare earth carbonates. The term “low” is used solely to indicate relative sulfate contents in different carbonates. Exemplary rare earth carbonates may be generated as wet cakes which is defined by weight percent total rare earth oxide (TREO) concentration.

In some instances, low sulfate rare earth carbonate may comprise between 0.1 and 2 wt. % sulfate (SO₄²⁻). In various implementations, low sulfate rare earth carbonate may comprise at least 0.1 wt % sulfate; at least 0.25 wt % sulfate; at least 0.50 wt % sulfate; at least 0.75 wt % sulfate; at least 1 wt. % sulfate; at least 1.5 wt. % sulfate; or at least 1.75 wt. % sulfate. In various implementations, low sulfate rare earth carbonate may comprise no more than 2.0 wt. % sulfate; no more than 1.75 wt. % sulfate; no more than 1.5 wt. % sulfate; no more than 1.25 wt. % sulfate; no more than 1.0 wt. % sulfate; no more than 0.75 wt % sulfate; no more than 0.50 wt % sulfate; no more than 0.25 wt % sulfate; or no more than 0.10 wt % sulfate. In various implementations, low sulfate rare earth carbonate may comprise 0.1-2.0 wt. % sulfate; 0.2-1.5 wt. % sulfate; 0.5-1.0 wt. % sulfate; or 1.0-2.0 wt. % sulfate.

In some instances, low sulfate rare earth carbonate may comprise between 25 wt. % and 60 wt. % rare earth oxide (REO). In various implementations, low sulfate rare earth carbonate may comprise at least 25 wt. % REO; at least 30 wt. % REO; at least 35 wt. % REO; at least 40 wt. % REO; at least 45 wt. % REO; least 50 wt. % REO; at least 55 wt. % REO; or at least 60 wt. % REO. In various implementations, low sulfate rare earth carbonate may comprise no more than 60 wt. % REO; no more than 55 wt. % REO; no more than 50 wt. % REO; no more than 45 wt. % REO; no more than 40 wt. % REO; no more than 35 wt. % REO; or no more than 30 wt. % REO. In various implementations, low sulfate rare earth carbonate may comprise 30-60 wt. % REO; 35-55 wt. % REO; 40-50 wt. % REO; 45-55 wt. % REO; or 50-60 wt. % REO.

In some instances, low sulfate rare earth carbonate may have a Loss of Ignition (LOI) of about 40% to about 80%. In various implementations, low sulfate rare earth carbonate may have an LOI of no less than 40%; no less than 45%; no less than 50%; no less than 55%; no less than 60%; no less than 65%; no less than 70%; no less than 75%; or no less than 80%. In various implementations, low sulfate rare earth carbonate may have an LOI of no greater than 80%; no greater than 75%; no greater than 70%; no greater than 65%; no greater than 60%; no greater than 55%; no greater than 50%; no greater than 45%; or no greater than 40%.

### III. Example Methods

Example methods for preparing rare earth carbonates disclosed and contemplated herein can include one or more operations. Broadly, exemplary methods include one or more conversion operations and one or more sulfate removal operations. In various implementations, some, most, or all operations in exemplary methods may be arranged and performed continuously (i.e., not in a batch operation).

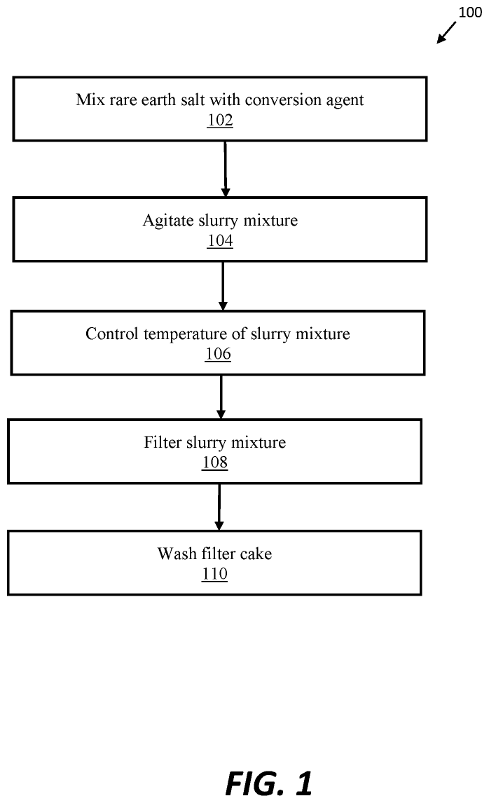

FIG. 1 shows an example method 100 for preparing rare earth carbonates. Example method 100 may begin by mixing, in a vessel, a rare earth double sulfate salt with a conversion agent to form a slurry mixture (operation 102). Exemplary conversion agents are described in greater detail above and may comprise a sodium carbonate (Na₂CO₃) solution.

In some implementations, the slurry mixture is agitated using an agitator and the temperature controlled using a temperature controlling device. In some instances, the temperature of the rare earth double sulfate salt and/or the conversion agent solution may be ambient temperature.

In some instances, a temperature of the conversion agent, prior to mixing with the rare earth double sulfate salt solid, may be between about 25° C. and about 35° C. In various implementations, a temperature of the conversion agent, prior to mixing with the rare earth double sulfate salt, may be at least 25° C.; at least 30° C.; or at least 35° C. In various implementations, a temperature of the conversion agent, prior to mixing with the rare earth double sulfate salt solid, may be no more than 35° C.; no more than 30° C.; or no more than 25° C. In various implementations, a temperature of the conversion agent, prior to mixing with the rare earth double sulfate salt solid, may be between 25° C. and 35° C.; between 25° C. and 30° C.; between 30° C. and 35° C.; or between 27° C. and 32° C.

In some implementations, a pH of the slurry mixture may be monitored and/or controlled to be between about 9.0 and about 11.5. In various instances, a pH of the slurry mixture may be at least 9.0; at least 9.5; at least 10.0; at least 10.5; or at least 11.0. In some implementations, a pH of the slurry mixture may be no more than 11.5; no more than 11.0; no more than 10.5; no more than 10.0; or no more than 9.5. For instance, a pH of the slurry mixture may be controlled to be between about 9.0 and about 11.5; between about 9.0 and 11.0; between about 9.5 and about 10.5; between about 9.75 and about 10.25; between about 9.9 and about 10.1; between about 9.8 and about 10.0; between about 9.95 and 10.05; or between about 9.99 and about 10.01.

Various relative amounts of rare earth double sulfate salt solids and conversion agent may be combined in exemplary slurry mixtures. In some instances, a weight ratio of rare earth double sulfate salt solids to conversion agent in exemplary slurry mixtures may be between 1.8:1 and 2:1; between 1.8:1 and 1.9:1; between 1.85:1 and 1.95:1; or between 1.85:1 and 1.90:1.

Exemplary methods may also include generating a low sulfate rare earth carbonate wet cake from the slurry mixture. Generating the low sulfate rare earth carbonate wet cake may comprise one or more operations, such as agitating the slurry mixture (operation 104), controlling a temperature of the slurry mixture (operation 106), filtering the agitated slurry mixture to generate a filter cake (operation 108), and/or washing the filter cake with water (operation 110).

In some instances, agitating the slurry mixture (operation 104) may be controlled to promote the efficiency of conversion of rare earth double sulfate salt solid to low sulfate mixed rare earth carbonate. For example, agitating the slurry mixture (operation 104) may include axial mixing to ensure the slurry mixture is homogeneous during the conversion process.

In some instances, one or more fluid parameters may be monitored during agitating the slurry mixture (operation 104). For example, a viscosity may be monitored during agitation of the slurry mixture (operation 104).

In various implementations, agitating the slurry mixture (operation 104) may be performed with an agitation speed of at least about 300 rpm, at least about 400 rpm, or at least about 500 rpm. In various implementations, the agitation speed may be controlled to be no more than about 500 rpm, no more than about 400 rpm, or no more than about 300 rpm. In various implementations, the agitation speed may be controlled to be between 300 and 500 rpm, between 350 and 450 rpm, or between 375 and 425 rpm.

In various implementations, agitating the slurry mixture (operation 104) may be performed for a predetermined period of time. Exemplary predetermined periods may be between 1 hour and 10 hours. In various instances, agitating the slurry mixture may be performed for at least 1 hour; at least 2 hours; at least 3 hours; at least 4 hours; at least 5 hours; at least 6 hours; at least 7 hours; at least 8 hours; or at least 9 hours. In various instances, agitating the slurry mixture may be performed for no more than 10 hours; no more than 9 hours; no more than 8 hours; no more than 7 hours; no more than 6 hours; no more than 5 hours; no more than 4 hours; no more than 3 hours; or no more than 2 hours. In various instances, agitating the slurry mixture may be performed for 1 hour to 10 hours; 1 hour to 5 hours; 5 hours to 10 hours; 2 hours to 6 hours; or 3 hours to 5 hours.

In some instances, exemplary methods may include controlling the temperature of the slurry mixture (operation 106) to be within a desired temperature range while agitating the slurry mixture (operation 104). For example, a temperature of the slurry mixture may be controlled to be about 30° C. to about 60° C. In various implementations, a temperature of the slurry mixture may be controlled to be at least about 30° C.; at least about 35° C.; at least about 40° C.; at least about 45° C.; at least about 50° C.; at least about 55° C.; or at least about 60° C. In various implementations, a temperature of the slurry mixture may be controlled to be no more than about 60° C.; no more than about 55° C.; no more than about 50° C.; no more than about 45° C.; no more than about 40° C.; no more than about 35° C.; or no more than about 30° C. In various implementations, a temperature of the first mixture may be controlled to be between 20° C. and 60° C.; between 20° C. and 45° C.; between 20° C. and 35° C.; between 32° C. and 38° C.; between 34° C. and 36° C.; between 42° C. and 48° C.; between 44° C. and 46° C.; between 52° C. and 58° C.; or between 54° C. and 56° C.

Exemplary methods may include filtering the slurry mixture to generate a filter cake (operation 108). Various filtration systems capable of filtering slurry mixtures may be used. In some instances, filtering the slurry (operation 108) may include using an Essa-type pressure filter. Filtering the slurry mixture (operation 108) may include introducing a batch of slurry into a container, such as a cylindrical barrel.

Air pressure may be introduced into the container up to about 5 bar. Increasing the air pressure may increase the cake dryness. Brown kraft paper type may be positioned on top of a filter cloth that has a pore size of less than 1 μm.

Exemplary methods may include washing the filter cake with water (operation 110). The filter cake may be washed with deionized water. In some instances, a ratio of 1 kg filter cake to between 8 L and 12 L water; between 8 L and 10 L water; between 10 L and 12 L water; between 9 L and 11 L water; or between 9.5 L and 10.5 L water may be used.

In various instances, exemplary method 100 may include repeatedly washing (operation 110). For example, exemplary method 100 may include one washing (operation 110) sequence; 2 washing (operation 110) sequences; or 3 washing (operation 110) sequences. Washing (operation 110) may be performed by repulping the filtered cake with deionized water in each washing sequence.

### IV. Example Systems

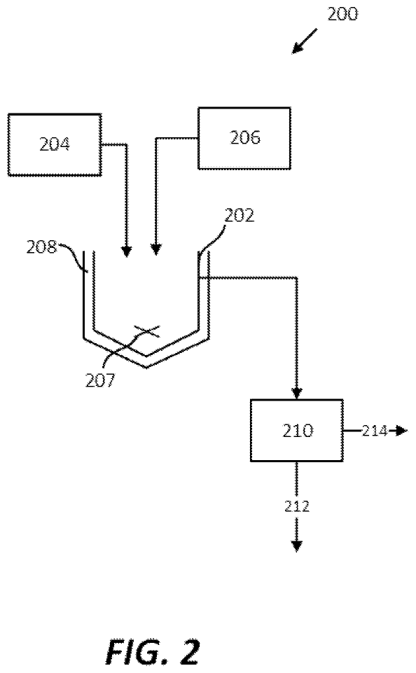

Various systems may be used to perform exemplary methods and techniques described herein. FIG. 2 is a schematic illustration of an exemplary system 200 for conversion of rare earth double sulfate salt solids to low sulfate rare earth carbonates. Exemplary system 200 includes a vessel 202, a rare earth double sulfate source 204, a conversion agent source 206, and a filter unit 210. Other embodiments may include more or fewer components.

The vessel 202 is in fluid communication with the rare earth double sulfate salt source 204. The vessel 202 is also in fluid communication with the conversion agent source 206. The vessel 202 includes a vessel agitation apparatus 207. In some instances, a vessel agitation apparatus 207 may include a propeller stirring device. Exemplary propeller-type stirring devices may include various configurations, such as a propeller with 3 blades. In some instances, baffles may be used in the vessel 202 as flow interrupting strips, which create turbulence and prevent vortex formation. For instance, 3 counter baffle plates may be used.

The vessel 202 may also include temperature regulation components 208 configured to maintain a vessel fluid temperature at desired temperatures. Various temperature regulation components known in the art may be used. For instance, exemplary temperature regulation components 208 may maintain a vessel fluid temperature between about 30° C. to about 60° C.

The filter unit 210 is in fluid communication with the vessel 202. The filter unit 210 generates a solids portion 212 comprising low sulfate rare earth carbonate and a liquid portion 214 comprising a filtrate. Various types of filters known in the art may be used as filter unit 210.

### V. Experimental Examples

Experimental example operations were conducted, and the results are discussed below.

### A. Conversion Operations

Nine experimental examples were conducted for conversion operations.

### 1. Raw Materials and Chemicals

Details about the rare earth sulfate solutions and the sodium carbonate solutions (conversion agent) are provided in Table 1 below. The concentrations for sodium carbonate solutions in grams per liter of 100 g/l, 200 g/l, and 300 g/l, are equivalent to 10 wt %, 20 wt %, and 30 wt %, respectively.

TABLE 1
Raw materials and chemical concentrations for
conversion operation experimental examples.

| | | Examples | | | | | | | | |
|---|---|---|---|---|---|---|---|---|---|---|
| | | 1 | 2 | 3 | 4 | 5 | 6 | 7 | 8 | 9 |
| Rare earth | Concentration | 35% | 35% | 35% | 35% | 35% | 35% | 35% | 35% | 35% |
| double sulfate | (wt % TREO) | | | | | | | | | |
| salt | | | | | | | | | | |
| Na₂CO₃ | Concentration | 100 | 200 | 300 | 100 | 200 | 300 | 100 | 200 | 300 |
| solutions | (g/l) | | | | | | | | | |

### 2. Process Conditions

The rare earth double sulfate salt solids and sodium carbonate solutions were combined in a vessel and agitated. The vessel contents were maintained to have a temperature of 35° C. +/−2° C., 45° C. +/−2° C., or 55° C. +/−2° C. An overhead agitator was used for mixing during the reaction period. Then the slurry mixture was transferred to the pressure filter, filtered, and washed. Table 2 below provides details for the nine experimental examples.

TABLE 2
Process parameters for experimental conversion operations.

| | | Examples | | | | | | | | |
|---|---|---|---|---|---|---|---|---|---|---|
| | | 1 | 2 | 3 | 4 | 5 | 6 | 7 | 8 | 9 |
| RE double | Mass | 300 | 300 | 300 | 300 | 300 | 300 | 300 | 300 | 300 |
| salt | (g) | | | | | | | | | |
| Na₂CO₃ | Mass | 158 | 158 | 158 | 158 | 158 | 158 | 158 | 158 | 158 |
| | (g) | | | | | | | | | |
| Na₂CO₃ | Volume | 1575 | 788 | 525 | 1575 | 788 | 525 | 1575 | 788 | 525 |
| | (ml) | | | | | | | | | |
| Reaction | Hours | 4 | 4 | 4 | 4 | 4 | 4 | 4 | 4 | 4 |
| time | | | | | | | | | | |
| pH | — | 9-11 | 9-11 | 9-11 | 9-11 | 9-11 | 9-11 | 9-11 | 9-11 | 9-11 |
| Agitation | Rpm | 400 | 400 | 400 | 400 | 400 | 400 | 400 | 400 | 400 |
| Speed | | | | | | | | | | |
| Reaction | 0 | 35.5 | 35.4 | 35.1 | 45.3 | 45.8 | 45.3 | 55.3 | 54.8 | 55.1 |
| Temperature | | | | | | | | | | |
| Total | ml | 1806 | 1018 | 756 | 1806 | 1018 | 756 | 1805 | 1018 | 756 |
| Volume | | | | | | | | | | |
| Washing | ml | 1050 | 1050 | 1050 | 1050 | 1050 | 1050 | 1050 | 1050 | 1050 |
| with DI | | | | | | | | | | |
| water | | | | | | | | | | |
| Filter | ml | 2100 | 2100 | 2100 | 2100 | 2100 | 2100 | 2100 | 2100 | 2100 |
| washing | | | | | | | | | | |
| with DI | | | | | | | | | | |
| water | | | | | | | | | | |
| Number of | — | 3 | 3 | 3 | 3 | 3 | 3 | 3 | 3 | 3 |
| washing | | | | | | | | | | |
| cycles | | | | | | | | | | |

### 3. Conversion Operations Results

Each example's generated low sulfate rare earth carbonate was analyzed by Inductively Coupled Plasma Optical Emission Spectroscopy (ICP-OES), rotational viscometry, Loss on Ignition (LOI), and X-ray Diffraction (XRD).

TABLE 3
Results from experimental conversion operations.

| | | Examples | | | | | | | | |
|---|---|---|---|---|---|---|---|---|---|---|
| | | 1 | 2 | 3 | 4 | 5 | 6 | 7 | 8 | 9 |
| Final pH of | — | 10.05 | 10.02 | 9.75 | 9.76 | 9.63 | 9.09 | 9.56 | 9.43 | 8.94 |
| supernatant | | | | | | | | | | |
| Avg viscosity | cP | 17.0 | 260 | 463 | 21.5 | 102 | 24.2 | 28.6 | 15.2 | 23.0 |
| REO in sample | wt % | 30.0 | 29.3 | 33.7 | 28.6 | 35.4 | 55.7 | 53.4 | 32.6 | 33.3 |
| (3x wash) | | | | | | | | | | |
| SO₄ in sample | wt % | 1.05 | 0.90 | 1.08 | 0.18 | 0.74 | 1.45 | 0.41 | 0.67 | 1.33 |
| (3x washing) | | | | | | | | | | |
| SO₄ removal | % | 88.7 | 77.5 | 59.3 | 88.0 | 78.0 | 72.0 | 90.0 | 77.6 | 80.4 |
| rate w/o washing | | | | | | | | | | |
| SO₄ removal | % | 97.6 | 98.0 | 97.5 | 99.6 | 98.3 | 96.7 | 99.1 | 98.5 | 97.0 |
| rate (3x washing) | | | | | | | | | | |

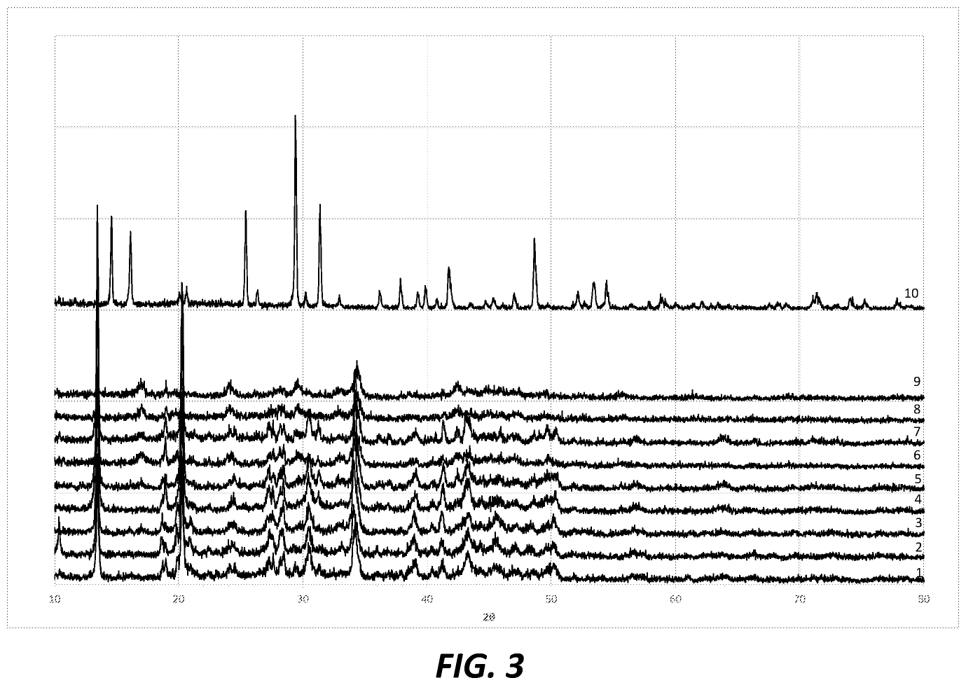

FIG. 3 and Table 4 show results of XRD analysis of example low sulfate rare earth carbonates (examples 1-9) and mixed rare earth double sulfate salt (sample 10).

TABLE 4
Degree of phase content for Examples 1 to 9 and Sample 10.

| | Crystal Phases | | | | | | | | Crystal |
|---|---|---|---|---|---|---|---|---|---|
| | [06- | [30- | [31- | [38- | [30- | [42- | [40- | | Size |
| Example/Sample | 0076] | 1223] | 1143] | 0377] | 0678] | 0593] | 1485] | unknown | (nm) |
| 1 | m | m | vs | vs | vs | vs | t | vs | 45 |
| 2 | m | m | s | s | s | s | t | vs | 55 |
| 3 | m | m | vs | vs | vs | vs | t | vs | 53 |
| 4 | m | m | vs | vs | vs | vs | t | vs | 48 |
| 5 | m | m | vs | vs | vs | vs | t | vs | 48 |
| 6 | s | m | s | s | s | s | t | s | 43 |
| 7 | m | m | vs | vs | vs | vs | t | vs | 54 |
| 8 | s | m | s | s | s | s | t | s | 97 |
| 9 | s | M | s | s | s | s | t | s | 19 |
| 10 | t | t | t | t | t | t | VM | vs | 74 |

Phases used in the comparison:

| | |
|---|---|
| [06-0076]: (Ce, La)₂(CO₃)₃•4H₂O | [30-0678]: (La, Nd)₂(CO₃)₃•8H₂O |
| [30-1223]: NaNd(CO₃)₂•6H₂O | [42-0593]: Nd₂(CO₃)₃•8H₂O |
| [31-1143]: Pr₂(CO₃)₃•8H₂O | [40-1485]: NaCe(SO₄)₂•H₂O |
| [38-0377]: Ce₂(CO₃)₃•8H₂O | |

Table 4 reflects the degree of phase content of exemplary mineral phases used in the comparison which is defined by: vast majority or VM (>70%), majority or M (50-70%), many or m (30-50%), small or s (10-30%), very small or vs (5-10%), and trace or t (<5%). Crystal size in nanometer (or nm) is calculated by Scherrer formula: d=kλ/βcosθ where k is a dimensionless shape factor (k˜0.9), λ is the x-ray wavelength (λ=1.54 Å Cu K-α), β is the line broadening at half the maximum intensity, and θ is the Bragg angle. Examples 1 to 5, and 7 have well-defined rare-earth carbonates crystal structures with high crystallinity. Examples 6, 8, and 9 have poor rare earth carbonate crystal structures, and low RE carbonates crystallinity. The dominant crystal structures found for examples 1 to 9 were rare earth (La, Ce, Pr) carbonate hydrates, mixed rare earth (e.g., LaCe or LaNd) carbonate hydrates, and a double salt of rare earth sodium carbonate hydrate. For the raw material used in the example conversion operations, sample 10, this material is a nearly pure double sulfate hydrate structure with high crystallinity.

### Exemplary Embodiments

For reasons of completeness, various aspects of the technology are set out in the following numbered embodiments:

Embodiment 1. A method for preparing a rare earth carbonate, the method comprising: mixing a rare earth double sulfate salt with a conversion agent comprising a sodium carbonate (Na₂CO₃) solution, thereby forming a slurry mixture; generating a low sulfate rare earth carbonate wet cake from the slurry mixture, wherein generating the low sulfate rare earth carbonate wet cake from the slurry mixture comprises: agitating the slurry mixture; filtering the slurry mixture to generate a filter cake; and washing the filter cake with water, the low sulfate rare earth carbonate wet cake comprising no more than 2 weight percent sulfate (SO₄²⁻).

Embodiment 2. The method according to Embodiment 1, wherein a solids content of the slurry mixture is 30 wt % to about 40 wt %; and wherein agitating the slurry mixture occurs for a predetermined period of time.

Embodiment 3. The method according to Embodiment 1 or Embodiment 2, wherein a temperature of the slurry mixture during agitating is about 30° C. to about 60° C.; and wherein an agitation speed for agitating the slurry mixture is between 300 rpm and 500 rpm.

Embodiment 4. The method according to Embodiment 2 or Embodiment 3, wherein the predetermined period is 1 hour to 10 hours.

Embodiment 5. The method according to Embodiment 4, wherein the predetermined period is 2 hours to 6 hours.

Embodiment 6. The method according to any one of Embodiments 1-5, wherein mixing the rare earth double sulfate salt solid with the conversion agent is performed continuously; and wherein generating the low sulfate rare earth carbonate wet cake from the slurry mixture is performed continuously.

Embodiment 7. The method according to any one of Embodiments 1-6, wherein the rare earth double sulfate salt is a solid and has a rare earth concentration of about 30 wt % to 40 wt % total rare earth oxide (TREO) content; wherein a concentration of the sodium carbonate (Na₂CO₃) solution is about 10 wt. % to about 30 wt. %.

Embodiment 8. The method according to Embodiment 7, wherein a weight ratio of rare earth double sulfate salt solids to conversion agent is between 1.8:1 and 2:1.

Embodiment 9. The method according to any one of Embodiments 1-8, wherein a total rare earth oxide (TREO) content of the low sulfate rare earth carbonate wet cake is about 20% to about 60%; wherein a Loss of Ignition (LOI) of the low sulfate rare earth carbonate wet cake is about 40% to about 80%; and wherein the sulfate content of the low sulfate rare earth carbonate wet cake is about 0.1% to about 2%.

Embodiment 10. The method according to any one of Embodiments 1-9, further comprising repeating washing the filter cake with water twice.

Embodiment 11. The method according to Embodiment 10, wherein a ratio of filter cake to water during washing is between 1 kg filter cake to 8 L water and 1 kg filter cake to 12 L water.

Embodiment 12. The method according to any one of Embodiments 1-11, wherein a temperature of the slurry mixture during agitating is between 34° C. and 36° C., between 44° C. and 46° C., or between 54° C. and 56° C.

Embodiment 13. A system for generating rare earth carbonates, the system comprising: a vessel in fluid communication with a rare earth double sulfate salt source and a sodium carbonate (Na₂CO₃) solution source, the vessel comprising vessel agitation apparatus; and a filter unit in fluid communication with the vessel.

Embodiment 14. The system according to Embodiment 13, the filter unit generating a solids portion comprising low sulfate rare earth carbonate and a liquid portion comprising filtrate.

Embodiment 15. The system according to Embodiment 13 or Embodiment 14, the vessel comprising temperature regulation components configured to maintain a vessel fluid temperature between about 30° C. to about 60° C.

Embodiment 16. The system according to any one of Embodiments 13-15, the vessel agitation apparatus configured to agitate vessel contents at a speed of 300 to 500 rpm.

Embodiment 17. A method for preparing a rare earth carbonate, the method comprising: mixing a rare earth double sulfate salt with a conversion agent comprising a sodium carbonate (Na₂CO₃) solution, thereby forming a slurry mixture, wherein a solids content of the slurry mixture is 30 wt % to about 40 wt %; and generating a low sulfate rare earth carbonate wet cake from the slurry mixture, the low sulfate rare earth carbonate wet cake comprising between 0.1 weight percent (wt %) and 2 wt % sulfate (SO₄²⁻); wherein generating the low sulfate rare earth carbonate wet cake from the slurry mixture comprises: agitating the slurry mixture; filtering the slurry mixture to generate a filter cake; and washing the filter cake with water.

Embodiment 18. The method according to Embodiment 17, wherein the rare earth double sulfate salt is a solid and has a rare earth concentration of about 30 wt % to 40 wt % total rare earth oxide (TREO) content; wherein a concentration of the sodium carbonate (Na₂CO₃) solution is about 10 wt. % to about 30 wt. %; and wherein a weight ratio of rare earth double sulfate salt solids to conversion agent is between 1.8:1 and 2:1.

Embodiment 19. The method according to Embodiment 17 or Embodiment 18, wherein a total rare earth oxide (TREO) content of the low sulfate rare earth carbonate wet cake is about 20% to about 60%; wherein a Loss of Ignition (LOI) of the low sulfate rare earth carbonate wet cake is about 40% to about 80%; wherein the sulfate content of the low sulfate rare earth carbonate wet cake is about 0.1% to about 2%; wherein a temperature of the slurry mixture during agitating is about 30° C. to about 60° C.; and wherein an agitation speed for agitating the slurry mixture is between 300 rpm and 500 rpm.

Embodiment 20. The method according to any one of Embodiments 17-19, further comprising repeating washing the filter cake at least once more; wherein agitating the slurry mixture occurs for 2 hours to 6 hours; wherein a ratio of filter cake to water during washing is between 1 kg filter cake to 8 L water and 1 kg filter cake to 12 L water; and wherein the temperature of the slurry mixture during agitating is between 34° C. and 36° C., between 44° C. and 46° C., or between 54° C. and 56° C.

It is understood that the foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use, may be made without departing from the spirit and scope of the disclosure.

1. A method for preparing a rare earth carbonate, the method comprising:
mixing a rare earth double sulfate salt with a conversion agent comprising a sodium carbonate (Na₂CO₃) solution, thereby forming a slurry mixture;
generating a low sulfate rare earth carbonate wet cake from the slurry mixture, wherein generating the low sulfate rare earth carbonate wet cake from the slurry mixture comprises:
agitating the slurry mixture;
filtering the slurry mixture to generate a filter cake; and
washing the filter cake with water,
the low sulfate rare earth carbonate wet cake comprising no more than 2 weight percent sulfate (SO₄²⁻).

2. The method according to claim 1, wherein a solids content of the slurry mixture is 30 wt % to about 40 wt %; and
wherein agitating the slurry mixture occurs for a predetermined period of time.

3. The method according to claim 2, wherein a temperature of the slurry mixture during agitating is about 30° C. to about 60° C.; and
wherein an agitation speed for agitating the slurry mixture is between 300 rpm and 500 rpm.

4. The method according to claim 2, wherein the predetermined period is 1 hour to 10 hours.

5. The method according to claim 4, wherein the predetermined period is 2 hours to 6 hours.

6. The method according to claim 2, wherein mixing the rare earth double sulfate salt solid with the conversion agent is performed continuously;
and wherein generating the low sulfate rare earth carbonate wet cake from the slurry mixture is performed continuously.

7. The method according to claim 1, wherein the rare earth double sulfate salt is a solid and has a rare earth concentration of about 30 wt % to 40 wt % total rare earth oxide (TREO) content;
wherein a concentration of the sodium carbonate (Na₂CO₃) solution is about 10 wt. % to about 30 wt. %.

8. The method according to claim 7, wherein a weight ratio of rare earth double sulfate salt solids to conversion agent is between 1.8:1 and 2:1.

9. The method according to claim 1, wherein a total rare earth oxide (TREO) content of the low sulfate rare earth carbonate wet cake is about 20% to about 60%;
wherein a Loss of Ignition (LOI) of the low sulfate rare earth carbonate wet cake is about 40% to about 80%; and
wherein the sulfate content of the low sulfate rare earth carbonate wet cake is about 0.1% to about 2%.

10. The method according to claim 1, further comprising repeating washing the filter cake with water twice.

11. The method according to claim 10, wherein a ratio of filter cake to water during washing is between 1 kg filter cake to 8 L water and 1 kg filter cake to 12 L water.

12. The method according to claim 1, wherein a temperature of the slurry mixture during agitating is between 34° C. and 36° C., between 44° C. and 46° C., or between 54° C. and 56° C.

13. A system for generating rare earth carbonates, the system comprising:
a vessel in fluid communication with a rare earth double sulfate salt source and a sodium carbonate (Na₂CO₃) solution source, the vessel comprising vessel agitation apparatus; and
a filter unit in fluid communication with the vessel.

14. The system according to claim 13, the filter unit generating a solids portion comprising low sulfate rare earth carbonate and a liquid portion comprising filtrate.

15. The system according to claim 13, the vessel comprising temperature regulation components configured to maintain a vessel fluid temperature between about 30° C. to about 60° C.

16. The system according to claim 13, the vessel agitation apparatus configured to agitate vessel contents at a speed of 300 to 500 rpm.

17. A method for preparing a rare earth carbonate, the method comprising:
mixing a rare earth double sulfate salt with a conversion agent comprising a sodium carbonate (Na₂CO₃) solution, thereby forming a slurry mixture,
wherein a solids content of the slurry mixture is 30 wt % to about 40 wt %; and
generating a low sulfate rare earth carbonate wet cake from the slurry mixture, the low sulfate rare earth carbonate wet cake comprising between 0.1 weight percent (wt %) and 2 wt % sulfate (SO₄²⁻);
wherein generating the low sulfate rare earth carbonate wet cake from the slurry mixture comprises:
agitating the slurry mixture;
filtering the slurry mixture to generate a filter cake; and
washing the filter cake with water.

18. The method according to claim 17, wherein the rare earth double sulfate salt is a solid and has a rare earth concentration of about 30 wt % to 40 wt % total rare earth oxide (TREO) content;
wherein a concentration of the sodium carbonate (Na₂CO₃) solution is about 10 wt. % to about 30 wt. %; and
wherein a weight ratio of rare earth double sulfate salt solids to conversion agent is between 1.8:1 and 2:1.

19. The method according to claim 18, wherein a total rare earth oxide (TREO) content of the low sulfate rare earth carbonate wet cake is about 20% to about 60%;
wherein a Loss of Ignition (LOI) of the low sulfate rare earth carbonate wet cake is about 40% to about 80%;
wherein the sulfate content of the low sulfate rare earth carbonate wet cake is about 0.1% to about 2%;
wherein a temperature of the slurry mixture during agitating is about 30° C. to about 60° C.; and
wherein an agitation speed for agitating the slurry mixture is between 300 rpm and 500 rpm.

20. The method according to claim 19, further comprising repeating washing the filter cake at least once more;
wherein agitating the slurry mixture occurs for 2 hours to 6 hours;
wherein a ratio of filter cake to water during washing is between 1 kg filter cake to 8 L water and 1 kg filter cake to 12 L water; and
wherein the temperature of the slurry mixture during agitating is between 34° C. and 36° C., between 44° C. and 46° C., or between 54° C. and 56° C.
